(19) United States
(12) Patent Application Publication
(10) Pub. No.: US 2020/0067659 A1
(43) Pub. Date: Feb. 27, 2020

(54) TRANSMISSION METHOD USED IN UPLINK HYBRID AUTOMATIC REPEAT REQUEST (HARQ) TRANSMISSION, AND MOBILE STATION

(71) Applicant: NTT DOCOMO, INC., Tokyo (JP)

(72) Inventors: Xiaohang CHEN, Beijing (CN); Anxin LI, Beijing (CN); Qun ZHAO, Beijing (CN); Huiling JIANG, Beijing (CN)

(73) Assignee: NTT DOCOMO, INC., Tokyo (JP)

(21) Appl. No.: 16/466,614

(22) PCT Filed: Jan. 8, 2018
(86) PCT No.: PCT/CN2018/071713

§ 371 Date: Jun. 4, 2019

(30) Foreign Application Priority Data
Jan. 8, 2017 (CN) 201710011897.1

(51) Int. Cl. H04L 1/18; H04W 28/04

(52) U.S. Cl. CPC H04L 1/1896; H04L 1/1812; H04W 28/04

(57) ABSTRACT

Embodiments of the present invention provide a transmission method used in uplink hybrid automatic repeat request (HARQ) transmission, a base station, and a mobile station. The transmission method used in uplink hybrid automatic repeat request (HARQ) transmission, which is applied to a base station, includes: receiving uplink transmission information sent from one or more terminal devices (UEs), the uplink transmission information sent by each UE comprising identifier information and data information of the UE; detecting the identifier information of the one or more UEs according to the uplink transmission information; and when identifier information that is not properly detected according to the uplink transmission information exists, sending a common failure response signal to multiple UEs connected to the base station.

### TECHNICAL FIELD

The present invention relates to a field of wireless communication, and particularly relates to a transmission method, a base station and a mobile station used in uplink Hybrid Automatic Repeat Request (HARQ) which can be used in a wireless communication system.

### BACKGROUND

In traditional uplink Hybrid Automatic Repeat Request (HARQ), when a base station does not correctly receive uplink transmission information sent by a terminal device (UE), the UE performs retransmissions of the uplink transmission information with a fixed time interval, that is, the UE performs the retransmissions of the uplink transmission information in a synchronous manner. However, when there are a plurality of UEs at the same time, if the uplink HARQ is performed in a synchronous manner, it is easy to cause collisions between uplink transmission information of various UEs since their transmission intervals are the same.

Asynchronous uplink HARQ for performing the retransmissions of the uplink transmission information with different transmission intervals has been proposed. In the asynchronous HARQ, a plurality of UEs perform the retransmission of the uplink transmission information with different transmission intervals, which reduces the possibility of the occurrence of the collisions between the uplink transmission information of the various UEs. When performing uplink transmission, the uplink transmission information of a UE generally includes identity information of the UE and data that the UE desires to send to a base station (also referred to as “data information”).

However, no matter in the synchronous uplink HARQ or in the asynchronous uplink HARQ, the base station does not distinguish between the identity information and the data of the UE when performing uplink transmission information feedback, and in the current uplink transmission information feedback method, the base station sends feedbacks for the various UEs, which results in lower efficiency of the uplink transmission information feedback, and Grant-free uplink transmission being not supported.

### SUMMARY

According to one aspect of the present invention, there is provided a transmission method used in uplink Hybrid Automatic Repeat Request (HARQ), applied to a base station, comprising: receiving uplink transmission information sent from one or more terminal devices (UEs), wherein the uplink transmission information sent by each UE includes identity information and data information of the UE; detecting the identity information of the one or more UEs according to the uplink transmission information; sending common Negative Acknowledgement signal to a plurality of UEs connected to the base station when there is identity information which cannot be correctly detected according to the uplink transmission information.

According to another aspect of the present invention, there is provided a transmission method used in uplink Hybrid Automatic Repeat Request (HARQ), applied to a terminal device (UE), comprising: sending uplink transmission information to a base station; when common Negative Acknowledgement signal sent by the base station is received and UE specific Acknowledgement signal is not received, performing a next retransmission by utilizing a random waiting interval.

According to another aspect of the present invention, there is provided a base station, comprising: a receiving unit, configured to receive uplink transmission information sent from one or more terminal devices (UEs), wherein the uplink transmission information sent by each UE includes identity information and data information of the UE; an identity information detecting unit, configured to detect the identity information of the one or more UEs according to the uplink transmission information; a sending unit, configured to send common Negative Acknowledgement signal to a plurality of UEs connected to the base station when there is identity information which cannot be correctly detected according to the uplink transmission information.

According to another aspect of the present invention, there is provided a terminal device (UE), comprising: a sending unit, configured to send uplink transmission information to a base station; a retransmission determining unit, configured to perform a next retransmission by utilizing a random waiting interval when common Negative Acknowledgement signal sent by the base station is received and UE specific Acknowledgement signal is not received.

In the above aspect of the present invention, the base station distinguishes between the identity information and the data information in the uplink transmission information, and the base station sends the common Negative Acknowledgement signal to the plurality of UEs connected thereto when there is identity information which cannot be correctly detected according to the uplink transmission information, so that even in the case of Grant-free, the user can be effectively fed back, and the efficiency of the uplink transmission information feedback is improved.

### BRIEF DESCRIPTION OF THE DRAWINGS

The foregoing and other objects, features and advantages of the present invention will become more apparent from the detailed description of the embodiments of the present invention in conjunction with the accompanying drawings.

FIG. 1 shows a flow chart of a transmission method used in uplink Hybrid Automatic Repeat Request (HARQ) and performed by a base station according to an embodiment of the present invention.

FIG. 2 shows a flow chart of a method for sending the specific Negative Acknowledgement signal for the first UE according to an embodiment of the present invention.

FIG. 3 shows a flow chart of a method for sending the specific Negative Acknowledgement signal for the first UE according to another embodiment of the present invention.

FIG. 4 shows a schematic diagram of a specific transmission scheme of a transmission method used in uplink Hybrid Automatic Repeat Request (HARQ) and performed by a base station according to an embodiment of the present invention.

FIG. 5 shows a flow chart of a transmission method 500 used in the uplink HARQ.

FIG. 6 shows a block diagram of a base station according to an embodiment of the present invention.

FIG. 7 shows a block diagram of a UE according to an embodiment of the present invention.

FIG. 8 is a diagram of an example representing the hardware composing of the base station and the UE according to embodiments of the present invention.

### DETAILED DESCRIPTION

A resource determining method, a base station and a mobile station according to embodiments of the present invention will be described below with reference to accompanying drawings. In the accompanying drawings, same reference numbers always refer to same elements. It should be understood that the embodiments described herein are merely illustrative, and should not be construed as limiting the scope of the present invention. Furthermore, UEs described herein may include various types of user terminal devices, such as mobile terminal (or referred to as “mobile station”) or fixed terminal, however, for convenience, the terms UE and terminal device sometimes may be used interchangeably in the following.

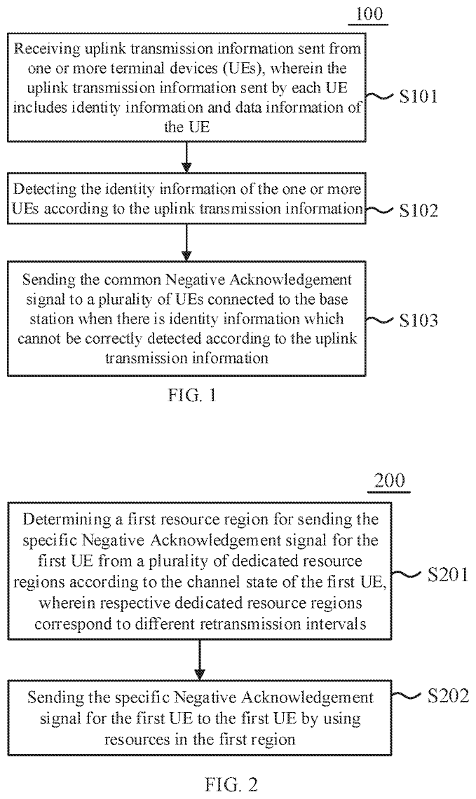

First, a transmission method used in uplink Hybrid Automatic Repeat Request (HARQ) and performed by a base station according to an embodiment of the present invention will be described with reference to FIG. 1. FIG. 1 shows a flow chart of a transmission method 100 used in the uplink HARQ. As shown in FIG. 1, in step S101, uplink transmission information sent from one or more terminal devices (UEs) is received, where the uplink transmission information sent by each UE includes identity information and data information of the UE. According to an example of the present invention, the uplink transmission information sent by each UE may include control channels or data channels, and the identity information of the UE may be explicitly notified to the base station via the control channels or the data channels. Alternatively, the identity information of the UE may be implicitly indicated to the base station by the manner of reference signal or paging sequences, etc.

Here, the so-called Hybrid Automatic Repeat Request (HARQ) mentioned in the full text may refer to a function of requesting a transmitter to retransmit information when a receiver fails to decode, and jointly decoding retransmission information and initial transmission information. Of course, the term HARQ is not a limitation, but rather an example, in fact, requests to implement similar functions (no matter what they are called) are applicable.

In step S102, the identity information of one or more UEs is detected according to the uplink transmission information. And in step S103, common Negative Acknowledgement signal is sent to a plurality of UEs connected to the base station when there is identity information which cannot be correctly detected according to the uplink transmission information. Specifically, in a case where a UE performs uplink transmission in Grant-free manner, when the base station fails to correctly detect the identity information according to the uplink transmission information at a certain time instant, it means that the base station cannot determine which UE sends the uplink transmission information to the base station at that time instant. Thus, the base station may send common Negative Acknowledgement signal to all UEs which may send data to the base station at that time instant. According to an example of the present invention, the plurality of UEs connected to the base station may be all UEs connected to the base station, or may be a part of all UEs connected to the base station, for example, a specific group of UEs.

According to an example of the present invention, the common Negative Acknowledgement signal may be indicated by common identity information, such as common HARQ identity or UE group identity. The common identity information may be pre-configured. For example, the common identity information may be appended to the common Negative Acknowledgement signal. As another example, the common Negative Acknowledgement signal may also be scrambled by using the common identity.

According to another example of the present invention, the common Negative Acknowledgement signal may be sent to the plurality of UEs connected to the base station by using resources of a predetermined common resource region in downlink channels. For example, a common resource region including one or more specific time or frequency resource blocks may be predetermined in downlink control channels, and the common Negative Acknowledgement signal may be sent to the plurality of UEs connected to the base station by using resources of this common resource region.

In addition, the above manner in which the common Negative Acknowledgement signal are indicated by the common identity information and in which the common Negative Acknowledgement signal is sent by using resources of the predetermined common resource region can be combined. That is, the common Negative Acknowledgement signal containing the common identity information may be sent by using resources of the predetermined common resource region.

In the transmission method used in the uplink HARQ and performed by the base station in the foregoing embodiment of the present invention, the base station distinguishes between the identity information and the data information in the uplink transmission information, and the base station sends the common Negative Acknowledgement signal to the plurality of UEs connected thereto when there is identity information which cannot be correctly detected according to the uplink transmission information, so that even in the case of Grant-free, the user can be effectively fed back, and the efficiency of the uplink transmission information feedback is improved.

Moreover, the method shown in FIG. 1 may further include sending a specific UE its specific Acknowledgement signal according to the fact that the data information of the specific UE is obtained by correct detection. Specifically, the method shown in FIG. 1 may further include: when the identity information of a first UE of the one or more UEs is correctly detected according to the uplink transmission information, the specific Acknowledgement signal for the first UE is sent according to whether the data information of the first UE is correctly detected from the uplink transmission information. For example, the specific Acknowledgement (ACK) signal for the first UE may be sent when the data information of the first UE is correctly detected from the uplink transmission information; on the other hand, the specific Negative Acknowledgement (NACK) signal for the first UE may be sent when the data information of the first UE is not correctly detected from the uplink transmission information.

According to an example of the present invention, the UE specific Acknowledgement signal may be sent via control channels such as common signaling. Alternatively, the UE specific Acknowledgement signal may also be sent via dedicated control channels (such as DCI) or data channels.

Moreover, for example, the UE specific Acknowledgement signal may be sent by resources of a region other than the above predetermined common resource region. For another example, in a case where the common Negative Acknowledgement signal is not transmitted on the above predetermined common resource region, the base station may use the common resource region to carry other Acknowledgement signal, such as the UE specific Acknowledgement signal.

Moreover, in order to reduce the probability of the occurrence of the collisions between transmissions of the plurality of UEs in the next transmission, and to effectively combine data from the plurality of UEs so as to improve transmission efficiency, preferably, the base station explicitly or implicitly indicates to the UE its retransmission waiting intervals by the manner of sending specific Negative Acknowledgement signal.

Specifically, FIG. 2 depicts a method of sending the specific Negative Acknowledgement signal for the first UE according to the embodiments of the present invention. FIG. 2 shows a method 200 of sending the specific Negative Acknowledgement signal for the first UE according to an embodiment of the present invention. As shown in FIG. 2, in step S201, a first resource region for sending the specific Negative Acknowledgement signal for the first UE is determined from a plurality of dedicated resource regions according to the channel state of the first UE, where various dedicated resource regions correspond to different retransmission intervals.

For example, frequency resources for sending the Negative Acknowledgement signal may be divided into a plurality of dedicated frequency resource regions, and different frequency resource regions may correspond to different retransmission intervals. For another example, time resources for sending the Negative Acknowledgement signal may be divided into a plurality of dedicated time resource regions, and different time resource regions may correspond to different retransmission intervals. In addition, the frequency resources for sending the Negative Acknowledgement signal may be further divided into a plurality of dedicated time-frequency resource regions, and different time-frequency resource regions may correspond to different retransmission intervals.

In addition, according to an example of the present invention, the channel state of the first UE may be determined according to the signal strength of the uplink transmission information sent by the first UE or the measurement report sent by the UE. For example, the first UE may determine its channel state according to downlink reference signal such as RSRP and/or RSRQ, and the determined channel state may be notified to the base station by the manner of preliminary definition or high layer signaling. For another example, the base station determines the channel state of the first UE according to the measurement report sent by the first UE or the uplink transmission signal sent by the UE.

In step S202, the specific Negative Acknowledgement signal for the first UE is sent to the first UE by using resources in the first region. Therefore, when the first UE detects the UE specific Negative Acknowledgement signal, it may determine its retransmission waiting interval according to the resource region on which the resources for sending the Negative Acknowledgement signal are located.

However, due to the limited frequency resources, when there are many UEs in the base station, it may not be possible to accurately indicate retransmission waiting times of respective UEs by the manner of dividing into frequency resource regions. On the other hand, the manner of indicating the retransmission waiting times of respective UEs by dividing into time resource regions may increase the delays of the UEs.

Therefore, a method of indicating the retransmission waiting intervals with different transmission formats is proposed. FIG. 3 depicts another method of sending the specific Negative Acknowledgement signal for the first UE according to the embodiment of the present invention. FIG. 3 shows a method 300 of sending the specific Negative Acknowledgement signal for the first UE according to another embodiment of the present invention. As shown in FIG. 3, in step S301, a first format corresponding to the specific Negative Acknowledgement signal for the first UE is determined from a plurality of specific formats according to the channel state of the first UE, where respective specific formats correspond to different retransmission intervals. Table. 1 shows an example of the correspondence between the specific formats and the retransmission intervals.

TABLE 1

| Specific Negative | Retransmission |
|---|---|
| Acknowledgement signal format | waiting time |
| Specific NACK format 1 | T1 |
| Specific NACK format 2 | T2 |
| . . . | . . . |
| Specific NACK format N | Tn |

In step S302, the specific Negative Acknowledgement signal for the first UE is sent to the first UE by using the first format. For example, in step S301, the specific NACK format 2 is determined according to the channel state in which the retransmission waiting time is T2, then the specific Negative Acknowledgement signal for the first UE will be sent to the first UE by using the specific NACK format 2 in step S302, and the retransmission waiting time T2 is indicated to the UE hereby.

In the method described in conjunction with FIG. 2 and FIG. 3, the base station may not notify the UE of the selection of the dedicated resource regions by signaling, and the UE may perform blind detection on the plurality of dedicated resource regions to determine which dedicated resource region the UE itself is located on. Alternatively, the specific Negative Acknowledgement signal for the first UE may be notified to the UE by high layer signaling or base station signaling. In addition, the base station can send an update instruction semi-statically so as to adjust the UE to a new dedicated resource region. For example, the base station can semi-statically notify the offset value from the original dedicated resource region.

In the examples described above in conjunction with FIG. 2 and FIG. 3, the base station indicates to the UE its retransmission waiting interval by sending the specific Negative Acknowledgement signal resource or format, so that the retransmission waiting interval of the UE is effectively controlled, instead of using random retransmission waiting interval. Therefore, it is beneficial for effectively combining data from a plurality of UEs in the next transmission to improve transmission efficiency.

Furthermore, the methods described above in conjunction with FIG. 2 and FIG. 3 can be used independently or in combination. For example, rough retransmission interval can be determined by using the method illustrated in FIG. 2, and finer retransmission interval can be further distinguished by using the method illustrated in FIG. 3, or vice versa.

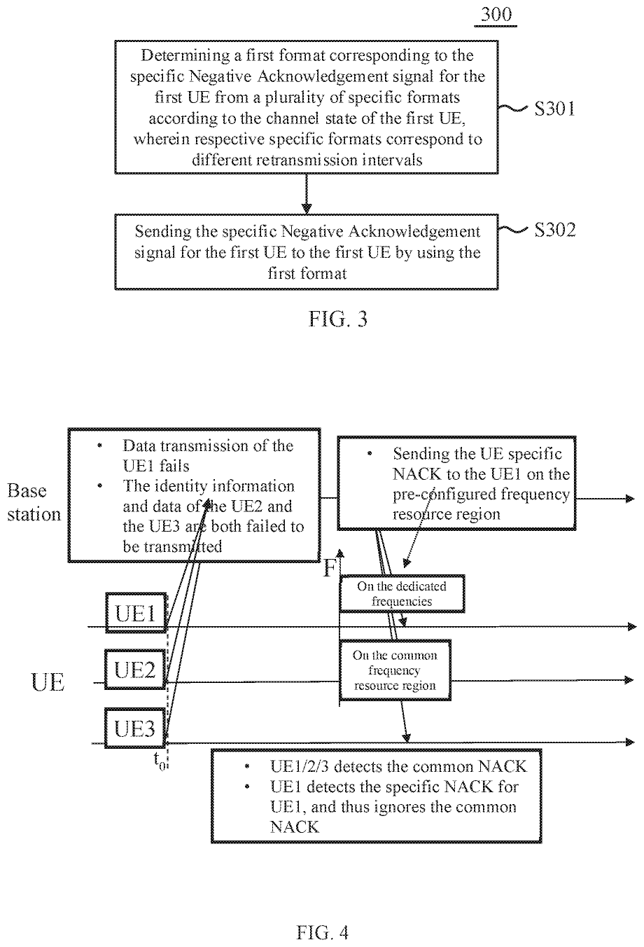

FIG. 4 is a diagram showing a specific transmission scheme of a transmission method used in uplink Hybrid Automatic Repeat Request (HARQ) and performed by a base station according to an embodiment of the present invention. A communication system in FIG. 4 includes a base station and three UEs, namely UE1, UE2, and UE3. In the example of FIG. 4, at time instant to, UE1, UE2, and UE3 send uplink transmission information to the base station respectively, and the uplink transmission information sent by each UE includes the identity information and the data information of this UE. The base station receives the uplink transmission information sent by UE1, UE2, and UE3, and detects the identity information of each UE according to the uplink transmission information. In this embodiment, the data transmission of UE1 fails, and the identity information and data of UE2 and UE3 are both failed to be transmitted. It can be seen that the base station can correctly detect the identity information of the UE1 according to the uplink transmission information of the UE1, but the base station fails to correctly detect the data information of the UE1, the base station thus send the specific Negative Acknowledgement signal (NACK) for UE1. In addition, since there is also identity information which cannot be correctly detected according to the uplink transmission information, the base station thus will also send the common Negative Acknowledgement signal (NACK) to UE1, UE2, and UE3 connected to the base station. The base station sends the NACK for UE1 on the pre-configured dedicated frequency resource region 1 corresponding to UE1, and sends common NACK on the common frequency resource region. Accordingly, at UE side, UE1, UE2, and UE3 will each detect the common NACK on the common frequency resource region, and UE1 will further detect the specific NACK for UE 1 on the dedicated frequency resource region 1 and thus will ignore the common NACK.

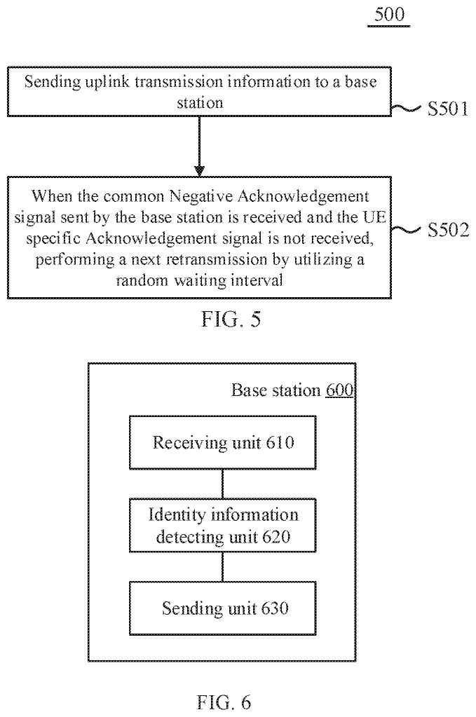

Next, a transmission method used in uplink Hybrid Automatic Repeat Request (HARQ) and performed by a terminal device (UE) according to an embodiment of the present invention will be described with reference to FIG. 5. FIG. 5 shows a flow chart of a transmission method 500 used in the uplink HARQ. As shown in FIG. 5, the uplink transmission information is sent to the base station in step S501. In step S502, when the common Negative Acknowledgement signal sent by the base station is received and the UE specific Acknowledgement signal is not received, a next retransmission is performed by utilizing a random waiting interval. The base station can use the methods described above in conjunction with FIGS. 1-3 to feed back the common Negative Acknowledgement signal and/or the specific Acknowledgement signal, and thus it will not be described again herein.

On the other hand, when the common Negative Acknowledgement signal sent by the base station is received and the UE specific Acknowledgement signal is also received, the common Negative Acknowledgement signal is ignored. That is to say, the UE specific Acknowledgement signal has a higher priority than the common Negative Acknowledgement signal. When the UE receives the UE specific Acknowledgement signal, the subsequent operations are performed according to the specific Acknowledgement signal, and the common Negative Acknowledgement signal is ignored.

In the transmission method used in the uplink HARQ and performed by the UE in the above embodiment of the present invention, the UE operates according to the common Negative Acknowledgement signal and the specific Acknowledgement signal, so that even in the case of Grant-free, the user can be effectively fed back, and the efficiency of the uplink transmission information feedback is improved.

Moreover, according to an example of the present invention, the UE may also determine its retransmission waiting interval according to the manner in which the base station sends the specific Negative Acknowledgement signal. Specifically, the method shown in FIG. 5 may further include: when the common Negative Acknowledgement signal sent by the base station is received and the UE specific Negative Acknowledgement signal is also received, the waiting interval of the next retransmission is determined according to the received UE specific Negative Acknowledgement signal.

For example, as described above in conjunction with FIG. 2, the resources for sending the Negative Acknowledgement signal may be divided into a plurality of dedicated frequency resource regions, time resource regions or time-frequency resource regions, and different frequency resource regions, time resource regions or time-frequency resource regions may correspond to different retransmission intervals. The UE may determine the waiting interval of the next retransmission according to the time resources or frequency resources by which the UE specific Negative Acknowledgement signal is sent. Specifically, the UE may determine, according to the time resources, frequency resources or time-frequency resources by which the specific Negative Acknowledgement signal for the UE is sent, the dedicated resource region on which the resources are located, and the UE may determine the waiting interval of the next retransmission according to the predetermined correspondence between the dedicated resource regions and the retransmission waiting intervals.

For another example, as described above in conjunction with FIG. 3 and Table. 1, the base station can indicate the retransmission waiting intervals with different transmission formats. Specifically, the UE may determine the waiting interval of the next retransmission according to the format of the UE specific Negative Acknowledgement signal.

In the above embodiments, the base station may not notify the UE of the selection of the dedicated resource regions by signaling, and accordingly, the UE may perform blind detection on the plurality of dedicated resource regions to determine which dedicated resource region the UE itself is located on. Alternatively, the UE may receive the UE specific Negative Acknowledgement signal which is notified by the base station through high layer signaling or base station signaling. In addition, the UE may also receive an update instruction semi-statically sent by the base station so as to determine the dedicated resource region to which the UE updates. For example, the UE may receive the offset value from the original dedicated resource region which is semi-statically notified by the base station.

Moreover, according to another example of the present invention, both the UE and the base station can determine the retransmission waiting time of the UE according to a predetermined function. In this case, the base station does not need to notify the UE of the waiting interval, and the UE can determine the retransmission waiting time itself according to this function.

Specifically, the method illustrated in FIG. 5 may further include: the retransmission waiting time of the UE is calculated according to the predetermined function. For example, the UE can calculate its retransmission waiting time by the function Tₖ shown in the following formula (1):

Tₖ=F(x)mod Tₘₐₓ

where Tₖ is the retransmission waiting time interval of UEₖ, F(x) is the generation function of the waiting interval according to x, and Tₘₐₓ is the maximum waiting interval.

Furthermore, the method shown in FIG. 5 may further include: when the common Negative Acknowledgement signal sent by the base station is received and the UE specific Negative Acknowledgement signal is also received, the next retransmission is performed according to the calculated retransmission waiting time.

In the examples, the UE determines its retransmission waiting interval according to the manner that the base station sends the specific Negative Acknowledgement signal resources or format or according to the predetermined function, so that the retransmission waiting interval of the UE is effectively controlled, instead of using random retransmission waiting interval. Therefore, it is beneficial for reducing the probability of the occurrence of the collisions between transmissions of a plurality of UEs in the next transmission, and for effectively combining data from the plurality of UEs so as to improve transmission efficiency.

Next, a base station according to an embodiment of the present invention will be described with reference to FIG. 6. FIG. 6 shows a block diagram of a base station 600 according to an embodiment of the present invention. As shown in FIG. 6, the base station 600 includes a receiving unit 610, an identity information detecting unit 620, and a sending unit 630. The base station 600 may include other components in addition to these three units, however, since these components are not related to the contents of the embodiments of the present invention, the illustration and description thereof are omitted herein. In addition, since the specific details of the following operations performed by the base station 600 according to the embodiments of the present invention are the same as those described above with reference to FIGS. 1-3, the repeated description of the same details is omitted herein to avoid repetition.

The receiving unit 610 receives uplink transmission information sent from one or more terminal devices (UEs), where the uplink transmission information sent by each UE includes identity information and data information of this UE. According to an example of the present invention, the uplink transmission information sent by each UE may include control channels or data channels, and the identity information of this UE may be explicitly notified to the base station via the control channels or the data channels. Alternatively, the identity information of this UE may be implicitly indicated to the base station by the manner of reference signal or paging sequences, etc.

The identity information detecting unit 620 detects the identity information of one or more UEs according to the uplink transmission information. And the sending unit 630 sends the common Negative Acknowledgement signal to a plurality of UEs connected to the base station when there is identity information which cannot be correctly detected according to the uplink transmission information. Specifically, in a case where a UE performs uplink transmission in Grant-free manner, when the base station fails to correctly detect the identity information according to the uplink transmission information at a certain time instant, it means that the base station cannot determine which UE sends the uplink transmission information to the base station at that time instant. Thus, the base station may send common Negative Acknowledgement signal to all UEs which may send data to the base station at that time instant. According to an example of the present invention, the plurality of UEs connected to the base station may be all UEs connected to the base station, or may be a part of all UEs connected to the base station, for example, a specific group of UEs.

According to an example of the present invention, the sending unit 630 may indicate the common Negative Acknowledgement signal by common identity information, such as common HARQ identity or UE group identity. The common identity information may be pre-configured. For example, the common identity information may be appended to the common Negative Acknowledgement signal. As another example, the common Negative Acknowledgement signal may also be scrambled by using the common identity.

According to another example of the present invention, the sending unit 630 may send the common Negative Acknowledgement signal to the plurality of UEs connected to the base station by using resources of a predetermined common resource region in downlink channels. For example, a common resource region including one or more specific time or frequency resource blocks may be predetermined in downlink control channels, and the common Negative Acknowledgement signal may be sent to the plurality of UEs connected to the base station by using resources of this common resource region.

In addition, the sending unit 630 may also combine the above manner in which the common Negative Acknowledgement signal are indicated by the common identity information and in which the common Negative Acknowledgement signal is sent by using resources of the predetermined common resource region. That is, the common Negative Acknowledgement signal containing the common identity information may be sent by using resources of the predetermined common resource region.

In the base station of the above embodiment of the present invention, the base station distinguishes between the identity information and the data information in the uplink transmission information, and the base station sends the common Negative Acknowledgement signal to the plurality of UEs connected thereto when there is identity information which cannot be correctly detected according to the uplink transmission information, so that even in the case of Grant-free, the user can be effectively fed back, and the efficiency of the uplink transmission information feedback is improved.

Moreover, the sending unit 630 may send a specific UE its specific Acknowledgement signal according to the fact that the data information of the specific UE is obtained by correct detection. Specifically, when the identity information of a first UE of the one or more UEs is correctly detected according to the uplink transmission information, the specific Acknowledgement signal for the first UE is sent according to whether the data information of the first UE is correctly detected from the uplink transmission information. For example, the specific Acknowledgement (ACK) signal for the first UE may be sent when the data information of the first UE is correctly detected from the uplink transmission information; on the other hand, the specific Negative Acknowledgement (NACK) signal for the first UE may be sent when the data information of the first UE is not correctly detected from the uplink transmission information.

According to an example of the present invention, the UE specific Acknowledgement signal may be sent via control channels such as common signaling. Alternatively, the UE specific Acknowledgement signal may also be sent via dedicated control channels (such as DCI) or data channels.

Moreover, for example, the UE specific Acknowledgement signal may be sent by resources of a region other than the above predetermined common resource region. For another example, in a case where the common Negative Acknowledgement signal are not transmitted on the above predetermined common resource region, the base station may use the common resource region to carry other Acknowledgement signal, such as UE-specific Acknowledgement signal.

Moreover, in order to reduce the probability of the occurrence of the collisions between transmissions of the plurality of UEs in the next transmission, and to effectively combine data from the plurality of UEs so as to improve transmission efficiency, preferably, the base station explicitly or implicitly indicates to the UEs their retransmission waiting intervals by the manner of sending specific Negative Acknowledgement signal.

Specifically, the base station 600 of the embodiment of the present invention may further include a resource determining unit (not shown in the figure), and the resource determining unit determines a first resource region for sending the specific Negative Acknowledgement signal for the first UE from a plurality of dedicated resource regions according to the channel state of the first UE, where various dedicated resource regions correspond to different retransmission intervals.

For example, the resource determining unit may divide frequency resources for sending the Negative Acknowledgement signal into a plurality of dedicated frequency resource regions, and different frequency resource regions may correspond to different retransmission intervals. For another example, the resource determining unit may divide time resources for sending the Negative Acknowledgement signal into a plurality of dedicated time resource regions, and different time resource regions may correspond to different retransmission intervals. In addition, the resource determining unit may further divide the frequency resources for sending the Negative Acknowledgement signal into a plurality of dedicated time-frequency resource regions, and different time-frequency resource regions may correspond to different retransmission intervals.

In addition, according to an example of the present invention, the channel state of the first UE may be determined according to the signal strength of the uplink transmission information sent by the first UE or the UE measurement report. For example, the first UE may determine its channel state according to downlink reference signal such as RSRP and/or RSRQ, and the determined channel state may be notified to the base station by the manner of preliminary definition or high layer signaling. For another example, the base station determines the channel state of the first UE according to the measurement report sent by the first UE or the uplink transmission signal sent by the UE.

Accordingly, the sending unit 630 sends the specific Negative Acknowledgement signal for the first UE to the first UE by using resources of the first region. Therefore, when the first UE detects the UE specific Negative Acknowledgement signal, it may determine its retransmission waiting interval according to the resource region on which the resources for sending the Negative Acknowledgement signal are located.

However, due to the limited frequency resources, when there are many UEs in the base station, it may not be possible to accurately indicate retransmission waiting times of various UEs by the manner of dividing into frequency resource regions. On the other hand, the manner of indicating the retransmission waiting times of the various UEs by dividing into time resource regions may cause the delays of the UEs to grow.

Therefore, the base station 600 of the embodiment of the present invention may further include a format determining unit (not shown in the figure), and the format determining unit determines a first format corresponding to the specific Negative Acknowledgement signal for the first UE from a plurality of specific formats according to the channel state of the first UE, where various specific formats correspond to different retransmission intervals, as shown in Table. 1.

Accordingly, the sending unit 630 sends the specific Negative Acknowledgement signal for the first UE to the first UE by using the first format.

In the above embodiments, the base station may not notify the UE of the selection of the dedicated resource regions by signaling, accordingly, the UE may perform blind detection on the plurality of dedicated resource regions to determine which dedicated resource region the UE itself is located on. Alternatively, the base station may notify the UE specific Negative Acknowledgement signal through high layer signaling or base station signaling. In addition, the base station may semi-statically send an update instruction so as to determine the dedicated resource region to which the UE updates. For example, the UE may receive the offset value from the original dedicated resource region which is semi-statically notified by the base station.

In the examples described above, the base station indicates to the UE its retransmission waiting interval by sending the specific Negative Acknowledgement signal resources or format, so that the retransmission waiting interval of the UE is effectively controlled, instead of using random retransmission waiting interval. Therefore, it is beneficial for effectively combining data from a plurality of UEs in the next transmission to improve transmission efficiency.

Furthermore, the above manner in which the base station indicates to the UE its retransmission waiting interval by sending the specific Negative Acknowledgement signal resources or format can be used independently or in combination. For example, rough retransmission interval can be determined by sending the specific Negative Acknowledgement signal resources, and finer retransmission interval can be further distinguished by sending the format of the specific Negative Acknowledgement signal, or vice versa.

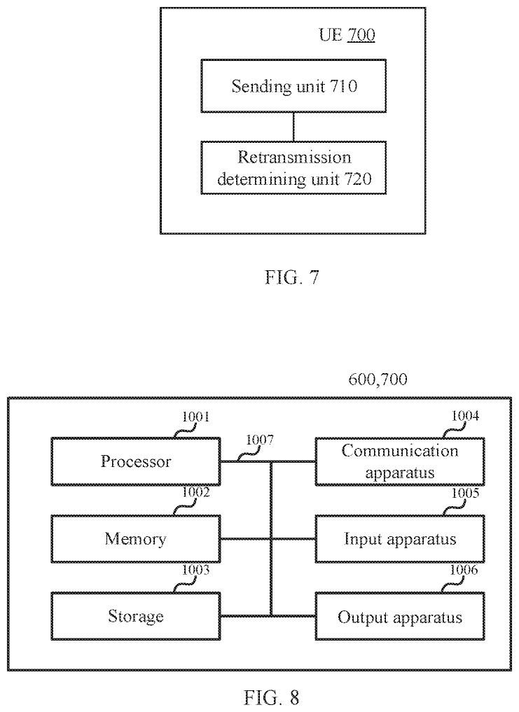

Next, a UE according to an embodiment of the present invention will be described with reference to FIG. 7. FIG. 7 shows a block diagram of a UE 700 according to an embodiment of the present invention. As shown in FIG. 7, the UE 700 includes a sending unit 710 and a retransmission determining unit 720. The UE 700 may include other components in addition to these two units, however, since these components are not related to the contents of the embodiments of the present invention, the illustration and description thereof are omitted herein. In addition, since the specific details of the following operations performed by the UE 700 according to the embodiments of the present invention are the same as those described above with reference to FIG. 5, the repeated description of the same details is omitted herein to avoid repetition.

Specifically, the sending unit 710 sends the uplink transmission information to the base station. When the common Negative Acknowledgement signal sent by the base station is received and the UE specific Acknowledgement signal is not received, the retransmission determining unit 720 performs a next retransmission by utilizing a random waiting interval. The base station can use the apparatus described above in conjunction with FIG. 6 to feed back the common Negative Acknowledgement signal and/or the specific Acknowledgement signal, and thus it will not be described again herein.

On the other hand, when the common Negative Acknowledgement signal sent by the base station is received and the UE specific Acknowledgement signal is also received, the common Negative Acknowledgement signal are ignored. That is to say, the UE specific Acknowledgement signal has a higher priority than the common Negative Acknowledgement signal. When the UE receives the UE specific Acknowledgement signal, the subsequent operations are performed according to the specific Acknowledgement signal, and the common Negative Acknowledgement signal is ignored.

In the UE of the above embodiment of the present invention, the UE operates according to the common Negative Acknowledgement signal and the specific Acknowledgement signal, so that even in the case of Grant-free, the user can be effectively fed back, and the efficiency of the uplink transmission information feedback is improved.

Moreover, according to an example of the present invention, the retransmission determining unit 720 may also determine its retransmission waiting interval according to the manner in which the base station sends the specific Negative Acknowledgement signal. Specifically, it can be included that when the common Negative Acknowledgement signal sent by the base station is received and the UE specific Negative Acknowledgement signal is also received, the waiting interval of the next retransmission is determined according to the received UE-dedicated Negative Acknowledgement signal.

For example, as described above, the base station may divide the frequency resources for sending the Negative Acknowledgement signal into a plurality of dedicated frequency resource regions, time resource regions or time-frequency resource regions, and different frequency resource regions, time resource regions or time-frequency resource regions may correspond to different retransmission intervals. The retransmission determining unit 720 of the UE 700 may determine the waiting interval of the next retransmission according to the time resources or frequency resources by which the UE specific Negative Acknowledgement signal is sent. Specifically, the retransmission determining unit 720 may determine, according to the time resources, frequency resources or time-frequency resources by which the UE specific Negative Acknowledgement signal is sent, the dedicated resource region on which the resources are located, and determine the waiting interval of the next retransmission according to the predetermined correspondence between the dedicated resource regions and the retransmission waiting intervals.

For another example, the base station can indicate the retransmission waiting intervals with different transmission formats. Specifically, the retransmission determining unit 720 may determine the waiting interval of the next retransmission according to the format of the UE specific Negative Acknowledgement signal.

In the above embodiments, the base station may not notify the UE of the selection of the dedicated resource regions by signaling, accordingly, the UE may perform blind detection on the plurality of dedicated resource regions to determine which dedicated resource region the UE itself is located on. Alternatively, the UE may receive the UE specific Negative Acknowledgement signal which is notified by the base station through high layer signaling or base station signaling. In addition, the UE may also receive an update instruction semi-statically sent by the base station so as to determine the dedicated resource region to which the UE updates. For example, the UE may receive the offset value from the original dedicated resource region which is semi-statically notified by the base station.

Moreover, according to another example of the present invention, both the UE and the base station can determine the retransmission waiting time of the UE according to a predetermined function. In this case, the base station does not need to notify the UE of the waiting interval, and the retransmission determining unit 720 of the UE 700 can determine the retransmission waiting time itself according to this function.

Moreover, when receiving the common Negative Acknowledgement signal sent by the base station and receiving the UE specific Negative Acknowledgement signal, the retransmission determining unit 720 may further perform the next retransmission according to the calculated retransmission waiting time.

In the examples, the UE determines its retransmission waiting interval according to the manner that the base station sends the resources or format of the specific Negative Acknowledgement signal or according to the predetermined function, so that the retransmission waiting interval of the UE is effectively controlled, instead of using random retransmission waiting interval. Therefore, it is beneficial for effectively combining data from a plurality of UEs in the next transmission to improve transmission efficiency.

It should be noted that the block diagrams used in the description of the above implementations represent functional blocks of functional units. These functional blocks (constituting parts) are realized by any combination of hardware and/or software. In addition, the means for realizing each functional block is not particularly limited. That it, each functional block may be implemented by one device that is physically and/or logically combined, or implemented by a plurality of devices by directly and/or indirectly (for example, wired and/or wireless) connecting two or more devices which are physically and/or logically separated.

For example, the base station, the UE, and the like in one implementation of the present invention can function as a computer that performs the processes of the transmission method of the present invention. FIG. 8 is a diagram of an example representing the hardware composing of the base station 600 and the UE 700 according to an implementation of the present invention. The above base station 600 and the UE 700 may be physically composed of a computer apparatus including a processor 1001, a memory 1002, a storage 1003, a communication apparatus 1004, an input apparatus 1005, an output apparatus 1006, a bus 1007, and the like.

It should be noted that in the following description, the term “apparatus” can be interpreted as a circuit, a device, a unit, etc. The hardware composing of the base station 600 and the UE 700 may be configured to include one or more various apparatuses, or may be configured to not include a part of the apparatuses.

The various functions of the base station 600 and the UE 700 are implemented by reading the specified software (program) on the hardware such as the processor 1001, the memory 1002 and the like, the processor 1001 performing calculations, and by controlling the communication performed by the communication apparatus 1004, and the reading and/or writing of data in the memory 1002 and the storage 1003.

The processor 1001 operates, for example, an operating system to control the entire computer. The processor 1001 may be composed of a Central Processing Unit (CPU) including interfaces with peripheral apparatuses, a control apparatus, an arithmetic apparatus, registers, and the like.

Further, the processor 1001 reads programs (program codes), software modules, and data from the storage 1003 and/or the communication apparatus 1004 to the memory 1002, and executes various processes in accordance with the contents thereof. As programs, the programs that cause a computer to perform at least a portion of the actions described in the above implementations are used. For example, the retransmission determining unit 720 of the UE 700 is stored in the memory 1002, and can be implemented by a control program operating on the processor 1001, and other functional blocks can be similarly implemented. The above various processes are mainly described to execute on one processor 1001, but may be execute by two or more processors simultaneously or sequentially. The processor 1001 may be implemented by one or more chips. It should be noted that the programs may be sent from the network via communication circuit.

The memory 1002 is a computer-readable recording medium, and may be composed of at least one of a ROM (Read Only Memory), an EPROM (Erasable Programmable ROM), an EEPROM (Electrically Erasable Programmable ROM), and a RAM (Random Access Memory). The memory 1002 can be called a register, a cache memory, a main memory (a main storage apparatus), or the like. The memory 1002 can store executable programs (program codes), software modules, and the like for implementing the wireless communication method of one implementation of the present invention.

The storage 1003 is a computer-readable recording medium, and for example, may be composed of at least one of an optical disk such as a CD-ROM (Compact Disc ROM), a hard disk drive, a diskette, a magneto-optical disk (for example, a compact disk, a digital versatile disk, or a Blue-ray (registered trademark) disk), a smart card, a flash memory (such as a flash memory card, a flash memory stick, a thin flash memory), a floppy disk (registered trademark), a magnetic stripe, etc. The storage 1003 may be referred to as an auxiliary storage device. The above storage medium may be, for example, other suitable medium including the memory 1002 and/or storage 1003 such as a database, a server, etc.

The communication apparatus 1004 is hardware (transceiver device) that performs communication between computers via a wired and/or wireless network, and is also referred to as a network device, a network controller, a network card, a communication module, and the like, for example.

The input apparatus 1005 is an input device (for example, a keyboard, a mouse, a microphone, a switch, a button, a sensor, etc.) that receives input from the outside. The output apparatus 1006 is an output device (for example, a display, a speaker, an LED lamp, etc.) that performs an external output. It should be noted that the input apparatus 1005 and the output apparatus 1006 may be an integrated structure (for example, a touch screen).

Further, various apparatuses such as the processor 1001 and the memory 1002 are connected by a bus through which information is communicated. The bus 1007 may be composed of a single bus or may be composed of different buses between apparatuses.

In addition, the base station 600 and the UE 700 may include hardware such as a microprocessor, a Digital Signal Processor (DSP), an ASIC (Application Specific Integrated Circuit), a PLD (Programmable Logic Device), an FPGA (Field Programmable Gate Array), and the like. The hardware can be used to implement a part of or all the various functional blocks. For example, the processor 1001 can be implemented by at least one of the hardware.

The base station can accommodate one or more (for example, three) (also referred to as segments) cells. In a case where the base station accommodates a plurality of cells, the coverage area of the base station as a whole can be divided into a plurality of smaller areas, each of the smaller areas can utilize a base station subsystem (for example, a small base station used in the house RRH: Remote Radio Head) to provide communication services. The terms “cell” or “segment” refer to a base station that performs communication services in the coverage area, and/or a part of or the whole of the coverage area of the base station subsystem. In addition, the terms “base station”, “eNB”, “cell” and “segment” can be used interchangeably in this specification. The base station sometimes is also referred to as fixed station, NodeB, eNodeB (eNB), access point, femto cell, small cell, and the like.

The UE vary from one skilled in the art, and is sometimes referred to as mobile station, subscriber station, mobile unit, subscriber unit, wireless unit, remote unit, mobile device, wireless device, wireless communication device, remote device, mobile subscriber station, access terminal, mobile terminal, wireless terminal, remote terminal, handheld device, user agent, mobile client, client, or other suitable terminology.

The specific actions performed by the base station in this specification are sometimes performed by its upper nodes due to the situation. In a network consisting of one or more network nodes having the base station, the various operations performed in order to communicate with the terminals can obviously be performed by the base station and/or an other network node other than the base station (for example, MME or S-GW, etc., but not limited thereto). The above exemplifies the case where there is one other network node other than the base station, but it may also be a combination of a plurality of other network nodes (for example, MME and S-GW).

The notification of the information is not limited to the manners/implementations illustrated in the present specification, and may be performed by other methods. For example, the notification of the information may be implemented by physical layer signaling (for example, DCI (Downlink Control Information), UCI (Uplink Control Information)), Upper layer signaling (such as RRC (Radio Resource Control) signaling, MAC (Medium Access Control) signaling, broadcast information (MIB (Master Information Block), SIB (System Information Block))), other signal, or a combination thereof. The information and the like can be output from the upper layer (or lower layer) to the lower layer (or upper layer). Input and output can be performed via a plurality of network nodes. The input, output Information and the like can be stored in a specific place (for example, memory), or managed by a management table. The input, output Information and the like can be overwritten, updated, or added. The output information can be deleted. The input information can be send to other apparatuses.

Each manner/implementation illustrated in this specification can be applied to LTE (Long Term Evolution), LTE-A (LTE-Advanced), SUPER 3G IMT-Advanced, 5G FRA (Future Radio Access), W-CDMA (registered trademark), GSM (registered trademark), CDMA2000, UMB (Ultra Mobile Broadband), IEEE 802.11 (Wi-Fi), IEEE 802.16 (WiMAX), IEEE 802.20, UWB (Ultra-WideBand), Bluetooth (registered trademark), the system that utilizes other suitable systems and/or the next-generation system that is extended based on these.

As long as the terms “including”, “comprising” and their deformation are used in the scope of the present specification or the claims, these terms similarly represent the meaning of comprising as the term “having”. Further, the term “or” as used in the scope of the specification or the claims is intended to mean not an exclusive or.

The determination may be performed by using a value (0 or 1) represented by 1 bit, or may be performed by a true or false value (Boolean: true or false), or may be performed by comparison of values (for example, comparison with a specified value). The processing steps, the sequences, the flowcharts, etc. of various manners/implementations described in the present specification may be replaced unless there is any contradiction. For example, the methods described in the present specification present the elements of the various steps in an exemplary order, and do not limit to the suggestive specific order.

Various manners/implementations described in the present specification may be used singly or in combination, and may be switched in accordance with execution. Further, notification of the specified information (for example, notification of the identity information, etc.) is not limited to be performed explicitly, but can also be performed implicitly (for example, without notification of the specified information).

Therefore, the present invention is explained in detail by using the above-described embodiments; however, it should be understood by those skilled in the art that the present invention is not limited to the embodiments explained herein. The invention can be implemented as modified, amended modes without departing from the scope of the invention as defined by the claims. Therefore, the description of the specification is only intended to explain the examples, and does not impose any limitation on the invention.

1-19. (canceled)

20. A terminal device (UE), comprising:
a sending unit, configured to send uplink transmission information to a base station;
a retransmission determining unit, configured to perform a next retransmission by utilizing a random waiting interval when common Negative Acknowledgement signal sent by the base station is received and UE-dedicated Acknowledgement signal is not received.

21. The UE of claim 20, wherein
when the common Negative Acknowledgement signal sent by the base station is received and the UE specific Acknowledgement signal is received, the retransmission determining unit ignores the common Negative Acknowledgement signal.

22. The UE of claim 20, wherein
when the common Negative Acknowledgement signal sent by the base station is received and UE specific Negative Acknowledgement signal is received, the retransmission determining unit is further configured to determine the waiting interval of the next retransmission according to the received UE specific Negative Acknowledgement signal.

23. The UE of claim 22, wherein
the retransmission determining unit determines the waiting interval of the next retransmission according to resources by which the UE specific Negative Acknowledgement signal is sent.

24. The UE of claim 22, wherein
the retransmission determining unit determines the waiting interval of the next retransmission according to format of the UE specific Negative Acknowledgement signal.

25. The UE of claim 20, wherein
the retransmission determining unit is further configured to calculate a retransmission waiting time of the UE according to a predetermined function,
when the common Negative Acknowledgement signal sent by the base station is received and UE dedicated Negative Acknowledgement signal is received, the retransmission determining unit performs the next retransmission according to the calculated retransmission waiting time.

26. A transmission method used in uplink Hybrid Automatic Repeat Request (HARQ), applied to a terminal device (UE), comprising:
sending uplink transmission information to a base station;
when a common Negative Acknowledgement signal sent by the base station is received and a UE specific Acknowledgement signal is not received, performing a next retransmission by utilizing a random waiting interval.

27. The method of claim 26, further comprising:
when the common Negative Acknowledgement signal sent by the base station is received and the UE specific Acknowledgement signal is received, the common Negative Acknowledgement signal is ignored.

28. The method of claim 26 further comprising:
when the common Negative Acknowledgement signal sent by the base station is received and the UE specific Negative Acknowledgement signal is received, determining the waiting interval of the next retransmission according to the received UE specific Negative Acknowledgement signal.

29. The method of claim 28, wherein determining the waiting interval of the next retransmission according to the received UE specific Negative Acknowledgement signal comprises:
determining the waiting interval of the next retransmission according to resources by which the UE specific Negative Acknowledgement signal is sent.

30. The method of claim 28, wherein determining the waiting interval of the next retransmission according to the received UE specific Negative Acknowledgement signal comprises:
determining the waiting interval of the next retransmission according to format of the UE specific Negative Acknowledgement signal.

31. The method of claim 26, further comprising:
calculating a retransmission waiting time of the UE according to a predetermined function,
when the common Negative Acknowledgement signal sent by the base station is received and the UE specific Negative Acknowledgement signal is received, performing the next retransmission according to the calculated retransmission waiting time.

32. A base station, comprising:
a receiving unit, configured to receive uplink transmission information sent from one or more terminal devices (UEs), wherein the uplink transmission information sent by each UE includes identity information and data information of the UE;
an identity information detecting unit, configured to detect the identity information of the one or more UEs according to the uplink transmission information;
a sending unit, configured to send common Negative Acknowledgement signal to a plurality of UEs connected to the base station when there is identity information which cannot be correctly detected according to the uplink transmission information.

33. The base station of claim 32, wherein
the sending unit sends the common Negative Acknowledgement signal to the plurality of UEs connected to the base station by using resources of a predetermined common resource region in downlink channels.

34. The base station of claim 32, wherein
the sending unit is further configured to send, when the identity information of a first UE of the one or more UEs is correctly detected according to the uplink transmission information, a specific Acknowledgement signal for the first UE according to whether the data information of the first UE is correctly detected from the uplink transmission information.

35. The base station of claim 34, wherein
the sending unit sends the specific Negative Acknowledgement signal for the first UE when the data information of the first UE is not correctly detected from the uplink transmission information.

36. The base station of claim 35, further comprising:
a resource determining unit, configured to determine a first resource region for sending a specific Negative Acknowledgement signal for the first UE from a plurality of dedicated resource regions according to channel state of the first UE, wherein respective dedicated resource regions correspond to different retransmission intervals, wherein
the sending unit sends the specific Negative Acknowledgement signal for the first UE to the first UE by using resources of the first region.

37. The base station of claim 35, further comprising:
a format determining unit, configured to determine a first format corresponding to the specific Negative Acknowledgement signal for the first UE from a plurality of specific formats according to channel state of the first UE, wherein respective specific formats correspond to different retransmission intervals, wherein
the sending unit sends the specific Negative Acknowledgement signal for the first UE to the first UE by using the first format.
